(19) United States
(12) Patent Application Publication
(10) Pub. No.: US 2010/0189882 A1
(43) Pub. Date: Jul. 29, 2010

(54) MANUFACTURE OF VARISTORS WITH A PASSIVATION LAYER

(75) Inventors: Ann Hopper, Blackrock (IE); John Curley, Dublin (IE); Declan McLoughlin, Robinstown (IE)

Correspondence Address: K&L Gates LLP, P.O. BOX 1135, CHICAGO, IL, 60690, US

(73) Assignee: LITTELFUSE IRELAND DEVELOPMENT COMPANY LIMITED, Dundalk, County Louth (IE)

(21) Appl. No.: 12/441,735

(22) PCT Filed: Sep. 19, 2006
(86) PCT No.: PCT/IE2006/000102

§ 371 Date: Apr. 12, 2010

(51) Int. Cl. B05D 5/12

(52) U.S. Cl. 427/102

(57) ABSTRACT

A method (1) of manufacturing an electronic component comprising an electro-ceramic body and conductive terminations is disclosed. The method (1) includes the steps of providing (10) an electro-ceramic body, applying (11) a termination material to the body, applying a passivation material, firing to cure the termination material to provide terminations and plating (15) the terminations. The component is fired (12) before application of the passivation material in a first stage to achieve a porous termination material of sufficient strength for subsequent processing. The passivation material is applied (13) to the porous passivation material and the body after said first stage firing. The component is subsequently fired (14) in a second stage after application of the passivation material, said second stage firing having parameters causing at least some of the passivation material overlying the terminations to diffuse into the porous termination material while leaving substantially intact the passivation material over the body. The termination material further comprises a sinter inhibitor (Pt, at 1.5 wt %) to assist with control of porosity of the termination material during first stage firing.

### FIELD OF THE INVENTION

The invention relates to manufacture of voltage dependent non-linear resistors (“varistors”) or other electro-ceramic electronic components having a partly-conducting body.

### PRIOR ART DISCUSSION

Varistors have been manufactured for many years. They comprise an electro-ceramic body, typically ZnO, and terminations for electrical contact. Most varistors are for surface mounting, and so the terminations are on end faces and around extremities of the four side faces. Since the 1980's many varistors have had interleaved internal electrodes. U.S. Pat. No. 6,535,105 (AVX), U.S. Pat. No. 5,565,838 (AVX) and U.S. Pat. No. 5,387,432 (Hubbell) describe such varistors.

A problem in manufacture of varistors is that of consistently achieving accurate plating of the terminations. This problem has become more acute in recent years with increasing miniaturisation. U.S. Pat. No. 6,535,105 describes application of a resin coating (“passivation”) which protects the ceramic from plating. However the resin coating underlies the metal of the terminations and may reduce quality of the electrical path between the inner electrodes and the termination plating. U.S. Pat. No. 5,565,83 describes an approach in which the terminations are sputtered over a passivation coating. Again, it appears that there may be insufficient consistency in electrical contact with the internal electrodes. U.S. Pat. No. 5,387,432 discloses passivation compositions.

The invention is directed towards providing a manufacturing method for varistors, with improved consistency and accuracy in plating of terminations.

### SUMMARY OF THE INVENTION

According to the invention, there is provided a method of manufacturing an electro-ceramic component comprising an electro-ceramic body and conductive terminations, the method comprising the steps of providing an electro-ceramic body, applying a termination material to the body, applying a passivation material, firing to cure the termination material to provide terminations, and plating the terminations, characterized in that,
the component is fired before application of the passivation material in a first stage to achieve a porous termination material of sufficient strength for subsequent processing,
the passivation material is applied to the porous passivation material and the body after said first stage firing, and
the component is subsequently fired in a second stage after application of the passivation material, said second stage firing having parameters causing at least some of the passivation material overlying the terminations to diffuse into the porous termination material while leaving substantially intact the passivation material over the body.

Because the passivation material diffuses into the termination material during second stage firing there is excellent plating of the terminations and yet still good protection for the electro-ceramic body during the plating. This assists with improving product yield.

In one embodiment, the termination material comprises Ag, glass frit, and carrier.

In one embodiment, the termination material further comprises a sinter inhibitor to assist with control of porosity of the termination material during first stage firing.

In one embodiment, the sinter inhibitor has a melting point greater than that of a primary component of the termination material.

In one embodiment, the sinter inhibitor comprises Pt.

In one embodiment, the Pt is present in a concentration of 0.1 wt % to 4 wt %.

In one embodiment, the Pt concentration is approximately 1.5 wt %.

In another embodiment, the sinter inhibitor comprises alumina.

In one embodiment, the passivation material comprises glass, binder, and water.

In another embodiment, the passivation material is applied by spraying.

In one embodiment, the spraying is conducted in a heated air flow.

In one embodiment, the first stage firing plateau temperature is in the range of 420° C. to 510° C.

In one embodiment, the first stage firing plateau temperature is in the range of 480° C. to 490° C.

In one embodiment, the first stage firing duration is 15 mins to 40 mins.

In a further embodiment, the first stage firing duration is 20 mins to 30 mins.

In one embodiment, the second stage firing plateau temperature is in the range of 630° C. to 710° C.

In one embodiment, the second stage firing plateau temperature is 650° C. to 670° C.

In one embodiment, the second stage firing duration is in the range of 5 mins to 35 mins.

In one embodiment, the second stage firing duration is in the range of 5 mins to 15 mins.

### BRIEF DESCRIPTION OF THE DRAWINGS

The invention will be more clearly understood from the following description of some embodiments thereof, given by way of example only with reference to the accompanying drawings in which:

FIG. 1 is a flow diagram illustrating a varistor manufacturing method of the invention;

FIGS. 2(a) to 2(c) are diagrams (not to scale) illustrating the varistor at stages of: (a) termination paste applied and varistor fired in first stage, (b) passivation coating applied, and (c) after second stage firing;

FIGS. 3(a) and 3(b) are profile plots showing firing temperatures vs. time for first and second stage firing respectively; and

FIGS. 4(a), 4(b) and 4(c) are cross-sectional images of (a) ceramic body and paste after first firing stage, (b) after second firing stage, and (c) after Nickel (Ni) and Tin (Sn) plating.

### DESCRIPTION OF THE EMBODIMENTS

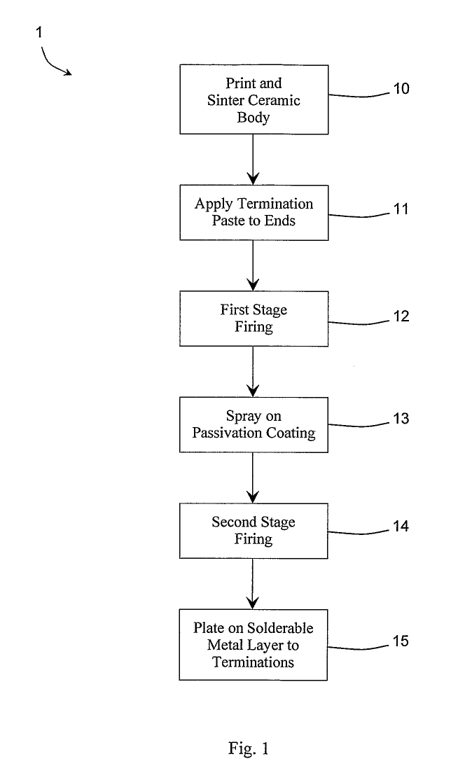

Referring to FIG. 1 a method 1 for manufacturing a varistor is shown.

In a step 10 a ZnO ceramic body with internal electrodes is manufactured in a conventional manufacturing technique. In a step 11 termination paste of Ag, Pt, glass frit, and vehicle is applied by dipping the terminations into the paste. The addition of Pt as a sinter inhibitor (in a concentration range of 0.1 wt % to 4.0 wt %) in the termination material is very advantageous as it helps to control the level of porosity by means of controlling the time/temperature of the firing process. The inhibitor is platinum, such as that commercially known as “platinum black” with a specific surface area of 12-18 m²/g. The termination paste material comprises in this embodiment 74 wt % (Ag) and 1.5 wt % (Pt), the remaining being glass frit and vehicle.

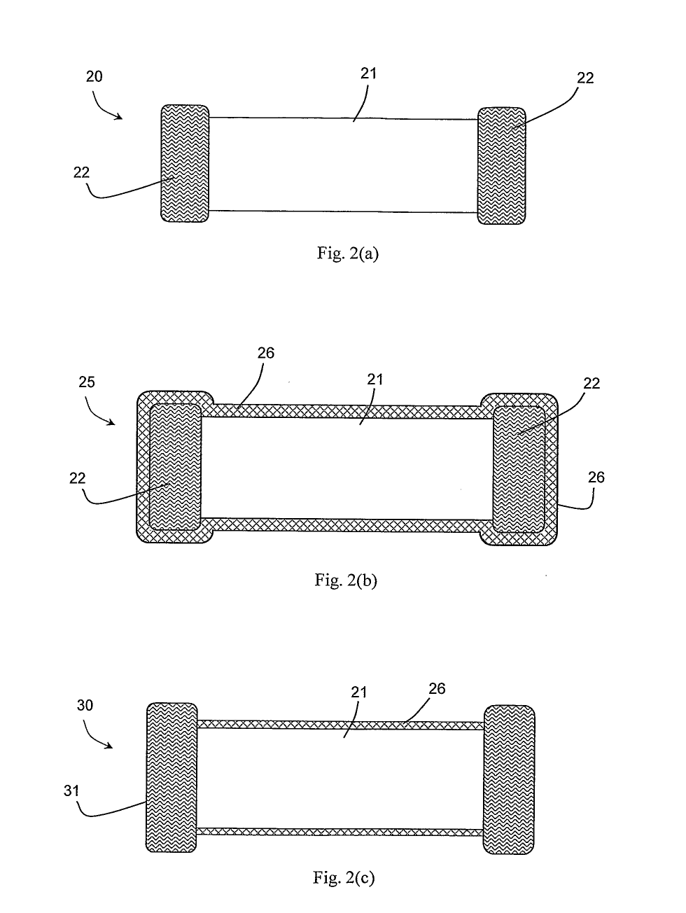

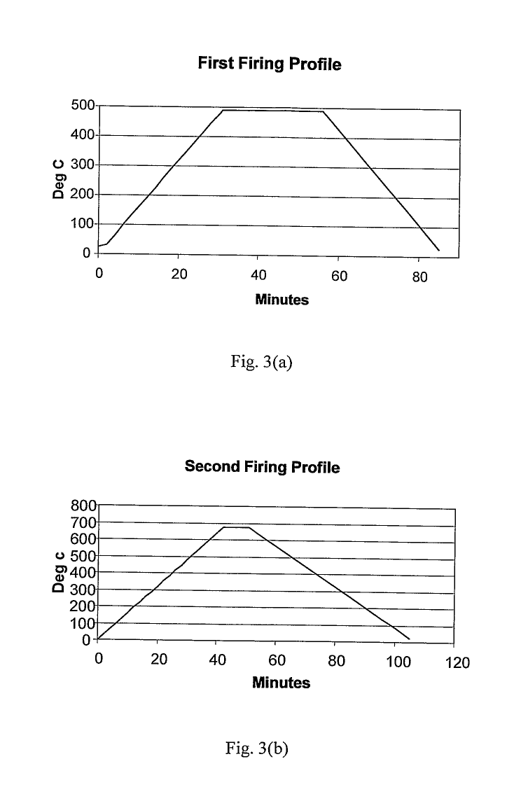

In a step 12, there is first stage firing to a plateau temperature in the range of 420° C. to 510° C., as shown by the plot of FIG. 3(a). Also, FIG. 2(a) diagrammatically shows the terminations after the first stage firing. The component is indicated by the numeral 20, the ceramic body (with internal electrodes) by 21, and the termination paste by 22. The temperature of the first stage firing is preferably within the smaller range of 480° C. to 490° C. The first stage firing plateau duration is in the range of 15 mins to 40 mins and is preferably within the smaller range of 20 mins. to 30 mins.

The sinter inhibitor has a higher melting point than the main termination paste component, Ag. It retards densification during sintering. For a pure silver termination the interfacial energy between the particles is relatively low and so at the first stage firing conditions a greater level of densification would be achieved. However the addition of the platinum in the silver termination material increases the interfacial energy required to initiate densification. At the given first firing conditions the higher interfacial energy requirement leads to a low level of densification.

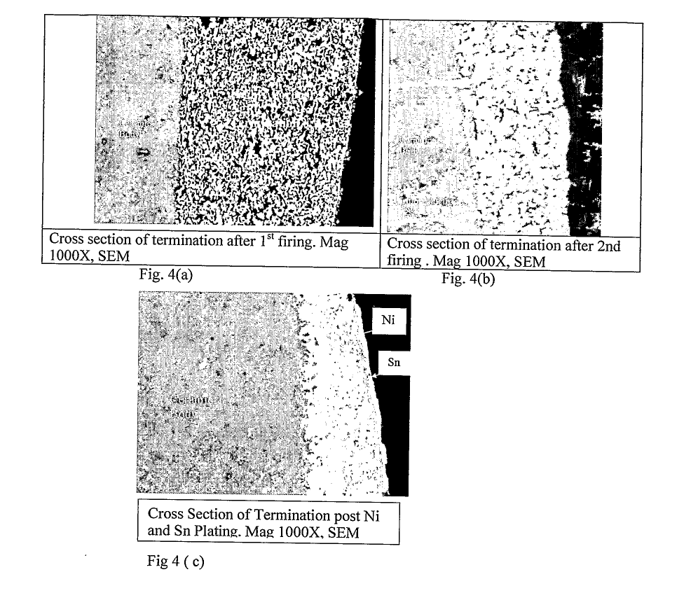

The aim of the first stage firing is to melt the glass in the paste first sufficiently to bind the Ag particles together without allowing the silver to densify. The termination is thus porous, however, it has sufficient strength to allow subsequent processing. FIG. 4(a) is an image of a termination after the first stage firing in which the porosity of the paste is visible.

In a step 13 a passivation material of silica glass fit is applied by spraying the complete component whilst heating and rotating to ensure that all sides are adequately coated. In this embodiment this is achieved by “fluidizing” the components in a warm airflow in an atmosphere of misted passivation material. The passivation material sprayed on comprises 13.5 wt % glass frit, 1 wt % latex binder, and the remainder deionised water. The “fluidizer” operates with an outlet temperature of between 39° C. and 44° C. with an airflow of c. 100 m³/hr to ensure thorough drying of the components. FIG. 2(b) shows a component 25 after application of the passivation material, 26, clearly extending over all surfaces.

In a step 14 the components are fired in a second stage with a profile shown in FIG. 3(b). The range of plateau temperature is 630° C. to 710° C. and most preferably in the sub-range of 650° C. to 670° C. The corresponding times are 5 mins to 35 mins and most preferably 5 mins to 15 mins. This causes the passivation to melt and migrate into the termination due to its porosity, leaving a hard conductive Ag termination 31 as illustrated in FIG. 2(c). This diagram shows that the passivation layer 26 over the termination paste 22 has “disappeared” —diffusing into the porous termination during the second stage firing. However, the passivation layer 26 remains on the surfaces of the ceramic body between the terminations, to protect the ceramic during subsequent processing. A cross-section of the termination material after second stage firing is shown in FIG. 4(b) in which the reduced porosity is apparent.

In a step 15 a nickel barrier layer followed by a solderable Sn or Sn/Pb alloy is selectively plated onto the termination by electroplating as shown in FIG. 4(c). Because the ceramic between the terminations is protected by the passivation there is little risk of it being plated. At the same time the terminations are well plated because the passivation layer has diffused into the terminations during second stage firing—leaving exposed Ag as an excellent host for electroplating.

The passivation material may alternatively be applied by rotation in a “pan coater”, such that the units are tumbled in a heated chamber into which a fine spray of the passivation material is injected.

It will be appreciated that the invention provides for excellent selectivity in plating of terminations. Heretofore, the plating process parameters for such devices have required very tight control on variations in electroplating chemistry, time and current density. With the invention, there is greatly reduced possibility of glass remaining on the surface of the termination, making the device more tolerant of variations in the plating process. Also, since there is diffusion of the glass into the termination it is possible to increase the amount of glass deposited on the component. The thickness of glass on the ceramic surface is proportional to the level of overplate that can occur. Prior art processes with tight control on the plating parameters would have typically a 7% yield loss due to overplate with a typical passivation glass deposit of 2-3 um. This overplate yield has been substantially reduced to less than 1% with the invention. In the prior processes whereby glass passivation is applied over the ceramic body and a normally fired termination (typically recommended firing temperature of 600′C) there is a trade-off between the amount of glass, the level of overplate and the thickness of the plated metals on the termination. If too much glass is applied there is a high risk that some of the glass will remain on the termination surface thus making plating more difficult and potentially resulting in a reduced metal coating. The benefit of a thicker glass laydown on the ceramic body is that there will be a low risk of plated metals being deposited on the body. Similarly if too little glass is applied, while the plating of the termination will be easier, there is the increased risk of plating occurring on the ceramic body due to the thin layer of glass passivation.

The invention overcomes these constraints because it has enabled the application of a thicker layer of glass passivation thereby reducing the overplate yield loss. This improved process has enabled a glass laydown of ˜6 um with excellent plating on the terminations and an overplate yield loss of typically less than 1%.

The invention is not limited to the embodiments described but may be varied in construction and detail. Other materials are suitable as sinter inhibitors, and one based on an alumina material and having a surface area of 13.5 m² has shown a similar effect. Low porosity can be achieved by firing a silver-only termination material, however this requires a lower temperature and while the porosity can be achieved the mechanical strength of the termination is lower and thus further processing of the devices is more difficult.

1. A method of manufacturing an electro-ceramic component comprising an electro-ceramic body and conductive terminations, the method comprising the steps of providing (10) an electro-ceramic body, applying (11) a termination material to the body, applying a passivation material, firing to cure the termination material to provide terminations, and plating (15) the terminations, characterized in that,
the component is fired (12) before application of the passivation material in a first stage to achieve a porous termination material of sufficient strength for subsequent processing,
the passivation material is applied (13) to the porous passivation material and the body after said first stage firing, and
the component is subsequently fired (14) in a second stage after application of the passivation material, said second stage firing having parameters causing at least some of the passivation material overlying the terminations to diffuse into the porous termination material while leaving substantially intact the passivation material over the body.

2. A method as claimed in any preceding claim, wherein the termination material comprises Ag, glass frit, and carrier.

3. A method as claimed in claim 2, wherein the termination material further comprises a sinter inhibitor to assist with control of porosity of the termination material during first stage firing.

4. A method as claimed in claim 3, wherein the sinter inhibitor has a melting point greater than that of a primary component of the termination material.

5. A method as claimed in claim 3 or 4, wherein the sinter inhibitor comprises Pt.

6. A method as claimed in claim 5, wherein the Pt is present in a concentration of 0.1 wt % to 4 wt %.

7. A method as claimed in claim 6, wherein the Pt concentration is approximately 1.5 wt %.

8. A method as claimed in claim 3 or 4, wherein the sinter inhibitor comprises alumina.

9. A method as claimed in any preceding claim, wherein the passivation material comprises glass, binder, and water.

10. A method as claimed in any preceding claim, wherein the passivation material is applied by spraying.

11. A method as claimed in claim 10, wherein the spraying is conducted in a heated air flow.

12. A method as claimed in any preceding claim, wherein the first stage firing plateau temperature is in the range of 420° C. to 510° C.

13. A method as claimed in claim 12, wherein the first stage firing plateau temperature is in the range of 480° C. to 490° C.

14. A method as claimed in any preceding claim, wherein the first stage firing duration is 15 mins to 40 mins.

15. A method as claimed in any preceding claim, wherein the first stage firing duration is 20 mins to 30 mins.

16. A method as claimed in any preceding claim, wherein the second stage firing plateau temperature is in the range of 630° C. to 710° C.

17. A method as claimed in claim 16, wherein the second stage firing plateau temperature is 650° C. to 670° C.

18. A method as claimed in any preceding claim, wherein the second stage firing duration is in the range of 5 mins to 35 mins.

19. A method as claimed in claim 18, wherein the second stage firing duration is in the range of 5 mins to 15 mins.
